(19) United States
(12) Patent Application Publication
(10) Pub. No.: US 2023/0401244 A1
(43) Pub. Date: Dec. 14, 2023

(54) INFORMATION PROCESSING METHOD, DEVICE, AND READABLE STORAGE MEDIUM

(71) Applicant: Lenovo (Beijing) Limited, Beijing (CN)

(72) Inventors: Chen SHENG, Beijing (CN); Heng CUI, Beijing (CN)

(21) Appl. No.: 18/121,506

(22) Filed: Mar. 14, 2023

(30) Foreign Application Priority Data
Jun. 13, 2022 (CN) 202210673494.4

(51) Int. Cl. G06F 16/332; G06N 20/00; G06F 40/20

(52) U.S. Cl. CPC G06F 16/3329; G06N 20/00; G06F 40/20

(57) ABSTRACT

An information processing method includes obtaining a conversation record. The conversation record includes a first conversation generated by a first conversation object and a second conversation generated by a second conversation object. The method further includes analyzing the conversation record to obtain at least two question-answer pairs. Each question-answer pair includes the first conversation as a question and the second conversation as a step. The step is a step of a solution corresponding to the question of the question-answer pair. One question corresponds to at least one solution. One solution includes at least one step. The method further includes determining a solution corresponding to each question in the conversation record based on features of the step, and displaying the question and the corresponding solution based on a generation process of the question in the conversation record to obtain a target abstract content of the conversation record.

### CROSS-REFERENCE TO RELATED APPLICATION

This application claims priority to Chinese Patent Application No. 202210673494.4, filed on Jun. 13, 2022, the entire content of which is incorporated herein by reference.

### TECHNICAL FIELD

The present disclosure relates to the information technology field and, more particularly, to an information processing method, a device, and a readable storage medium.

### BACKGROUND

One-to-one customer service is widely used in various business scenarios, such as product after-sale service consultation, robot online customer service in the medical field, and customer service consultation of a communication company. Compared to reading a long paragraph of a conversation log, a conversation abstract is used to help with quickly understanding questions that a user asks and responding with solutions.

However, the user may ask a plurality of questions simultaneously in one conversation in which topics intersect in language expression. A similar situation can occur at the customer service end. Different solutions are provided in response to the questions. The above conversation scenario can be referred to as a “multi-intention conversation.” Since a plurality of topics are involved, and the conversation sequence is interfered, a quality conversation abstract is difficult to be generated.

### SUMMARY

Embodiments of the present disclosure provide an information processing method. The method includes obtaining a conversation record. The conversation record includes a first conversation generated by a first conversation object and a second conversation generated by a second conversation object. The method further includes analyzing the conversation record to obtain at least two question-answer pairs. Each question-answer pair includes the first conversation as a question and the second conversation as a step. The step is a step of a solution corresponding to the question of the question-answer pair. One question corresponds to at least one solution. One solution includes at least one step. The method further includes determining a solution corresponding to each question in the conversation record based on features of the step and displaying the question and the corresponding solution based on a generation process of the question in the conversation record to obtain a target abstract content of the conversation record.

Embodiments of the present disclosure provide an information processing device, including an acquisition module, an analysis module, a determination module, and an abstract generation module. The acquisition module is configured to obtain a conversation record. The conversation record includes a first conversation generated by a first conversation object and a second conversation generated by a second conversation object. The analysis module is configured to analyze the conversation record to obtain at least two question-answer pairs. Each question-answer pair includes the first conversation as a question and the second conversation as a step. The step is a step of a solution corresponding to the question of the question-answer pair. One question corresponds to at least one solution, one solution includes at least one step. The determination module is configured to determine a solution corresponding to each question in the conversation record based on features of the step. The abstract generation module is configured to display the question and the corresponding solution based on a generation process of the question in the conversation record to obtain a target abstract content of the conversation record.

Embodiments of the present disclosure provide a non-transitory computer-readable storage medium storing a computer program that, when executed by a processor, causes the processor to obtain a conversation record. The conversation record includes a first conversation generated by a first conversation object and a second conversation generated by a second conversation object. The processor is further configured to analyze the conversation record to obtain at least two question-answer pairs. Each question-answer pair includes the first conversation as a question and the second conversation as a step. The step is a step of a solution corresponding to the question of the question-answer pair. One question corresponds to at least one solution, one solution includes at least one step. The processor can be further configured to determine a solution corresponding to each question in the conversation record based on features of the step and display the question and the corresponding solution based on a generation process of the question in the conversation record to obtain a target abstract content of the conversation record.

According to the technical solution, after the conversation record is obtained, the conversation record is analyzed to obtain the plurality of question-answer pairs. Each question-answer pair can include the first conversation used as the question and the second conversation used as the step. The step can be a step of the solution corresponding to the question in the question-answer pairs. One question can correspond to at least one solution. One solution can include at least one step. The solution corresponding to each question in the conversation record can be determined based on the features of the steps. The questions and the corresponding solutions can be displayed in sequence based on the generation process of the questions in the conversation record to obtain the target abstract content of the conversation record. In the present disclosure, in a multi-intention conversation scenario, each question-answer pair can be determined first. Then, the whole question-answer pairs can be sorted in sequence. The obtained target abstract content cannot be influenced by the chaotic sequence of the conversations in the conversation record even if the conversation sequence in the conversation record is chaotic. Thus, the quality of the target abstract content can be high. Moreover, since the noise data in the conversation record does not belong to any question-answer pair, the conversation information that does not belong to any question-answer pair cannot be added to the target abstract content to remove the noise from the conversation record.

### BRIEF DESCRIPTION OF THE DRAWINGS

FIG. 1 illustrates a schematic flowchart of an information processing method according to embodiments of the present disclosure.

FIG. 2 illustrates a schematic diagram showing a conversation record in an information processing method according to embodiments of the present disclosure.

FIG. 3 illustrates a schematic diagram of a target abstract in an information processing method according to embodiments of the present disclosure.

FIG. 4 illustrates a schematic flowchart of an information processing method according to embodiments of the present disclosure.

FIG. 5 illustrates a schematic flowchart of an information processing method according to embodiments of the present disclosure.

FIG. 6 illustrates a schematic flowchart of an information processing method according to embodiments of the present disclosure.

FIG. 7 illustrates a schematic flowchart of an information processing method according to embodiments of the present disclosure.

FIG. 8 illustrates a schematic flowchart of an information processing method according to embodiments of the present disclosure.

FIG. 9 illustrates a schematic flowchart of an information processing method according to embodiments of the present disclosure.

FIG. 10 illustrates a schematic flowchart of an information processing method according to embodiments of the present disclosure.

FIG. 11 illustrates a schematic flowchart of an information processing device according to embodiments of the present disclosure.

### DETAILED DESCRIPTION OF THE EMBODIMENTS

The technical solutions of embodiments of the present disclosure are described in detail below in connection with the accompanying drawings of embodiments of the present disclosure. Described embodiments are only some embodiments of the present disclosure, not all embodiments. All other embodiments obtained by those of ordinary skill in the art without creative effort are within the scope of the present disclosure.

FIG. 1 illustrates a schematic flowchart of an information processing method according to embodiments of the present disclosure. The method can be applied to an electronic apparatus. The electronic apparatus can include an apparatus having an information processing capability. The electronic apparatus can include an output structure. The method includes the following processes.

At S101, a conversation record is obtained.

The conversation record can at least include a first conversation generated by a first conversation object and a second conversation generated by a second conversation object.

The conversation record can include a record of a conversation process performed by a certain user and a customer service. The conversation process can be performed by the user through a personal apparatus (e.g., a mobile terminal, a personal computer, etc.) with a customer service server or can be performed by the user through a client terminal (e.g., a teller machine, etc.) with the customer service server.

The conversation record can be obtained. The conversation record can include the conversation generated by two parties of the conversation.

In some embodiments, the conversation record can include the first conversation generated by the first conversation object and the second conversation generated by the second conversation object.

For example, the first conversation object can be the user, and the second conversation object can be customer service. The user can consult for a certain question or questions. Customer service can respond to the questions. The content generated in the process can be the conversation record involved in embodiments of the present disclosure.

At S102, the conversation record is analyzed to obtain at least two groups of question-answer pairs.

Each question-answer pair can include the first conversation as a question and the second conversation as a step. The step can be a step of a solution corresponding to the questions in the question-answer pair. One question can correspond to at least one solution. One solution can include at least one step.

The conversation record can be a record of a multi-intention scenario conversation. In some embodiments, the conversation record can include a plurality of questions and corresponding responses.

The conversation record can include the plurality of questions and the plurality of responses for the plurality of questions, which form the question-answer pairs.

Each question-answer pair can include one question and one step.

One question can correspond to one solution. When one solution only has one step, one question-answer pair can represent the question and the corresponding solution. When the solution has a plurality of steps, the plurality of question-answer pairs obtained in the step can be related to the same question.

The questions and the steps of the responses in the conversation record can have a topic intersection in language expression.

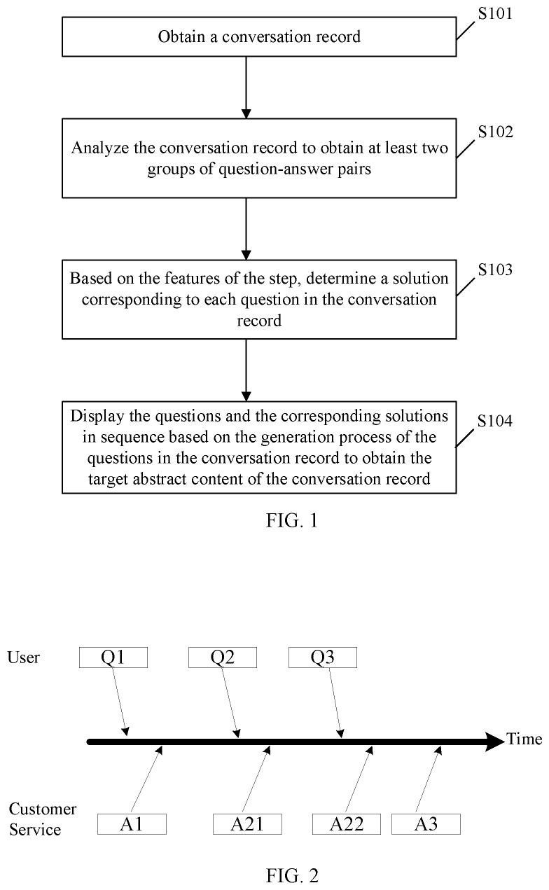

FIG. 2 illustrates a schematic diagram showing a conversation record in an information processing method according to embodiments of the present disclosure. Based on a time axis, the user first asks question Q1, and customer service replies with solution 1. Solution 1 has only one step A1. The user asks question Q2, and customer service replies with solution 2. Solution 2 has two steps A21 and A22. The user asks question Q3 after customer service replies with step A21 and before customer service replies with step A22. Customer service continues to reply with solution 3 for question Q3 after replying with step A22. Solution 3 has only one step A3.

If the conversation record is analyzed, some conversations (the first conversation and/or the second conversation) cannot form a question-answer pair. Thus, the conversations that cannot form the question-answer pair can be used as noise.

For example, a conversation of the first conversation object at a start position of the conversation record can be “hello!”. A conversation of the second conversation object can be “Hello! What do you need?” A conversation of the first conversation object at the end position can be “Good, thank you.” A conversation of the second conversation object can be “No problem. I am happy to assist you.” These conversations can be unrelated to the questions and the solutions and cannot form the question-answer pair. Thus, these conversations can be ignored or deleted as noise.

At S103, based on the features of the step, a solution corresponding to each question in the conversation record is determined.

After a plurality of question-answer pairs are determined, if steps in the question-answer pairs belong to steps of a same question, the plurality of steps can be combined to obtain a solution to the question. If a question of a question-answer pair corresponds to only one step, the step of the question-answer pair can be determined as the solution to the question.

In some embodiments, the sequence of the steps in the solution can be fixed. In the conversations generated by the second conversation object, the steps of the same solution can be arranged in a time sequence. Thus, based on the time sequence in the conversation record, the steps can be combined to obtain the solution to the corresponding question.

In some embodiments, the sequence of the steps in the solution can be fixed. The steps can be continuous. Based on the continuity of the steps of the solution, the plurality of steps can be combined to obtain the solution to the corresponding question.

If the steps of a question-answer pair and the steps of any other question-answer pairs do not satisfy the corresponding features, the steps of the question-answer pairs can be the solution corresponding to the question. The question can only have one step.

If the steps of the question-answer pair and the steps of one or more question-answer pairs satisfy the corresponding features, the steps of the one or more question-answer pairs can form the solution corresponding to the question.

At S104, displaying the questions and the corresponding solutions in sequence based on the generation process of the questions in the conversation record to obtain the target abstract content of the conversation record.

After the noise in the conversation record is removed, the remaining content of the conversation record with substantial questions and answer content can include the questions and the corresponding solutions.

In some embodiments, a generation sequence of the questions in the conversation record can be used to determine a display sequence of the questions in the conversation record and the corresponding solutions to obtain the target abstract content of the conversation record.

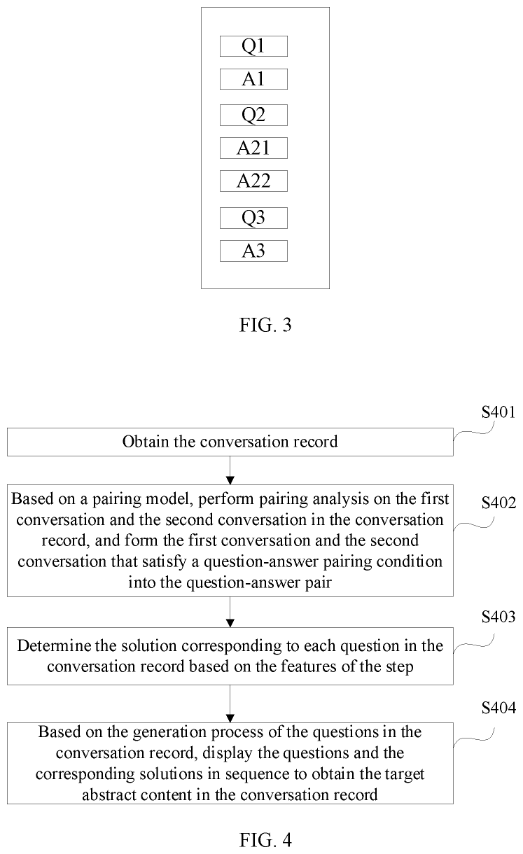

FIG. 3 illustrates a schematic diagram of the target abstract in the information processing method according to embodiments of the present disclosure. The target abstract content sequentially includes question 1Q1 and step A1 of solution 1, question 2Q2 and step A21 and step A22 of solution 2, and question 3Q3 and step A3 of solution 3.

In summary, the information processing method of embodiments of the present disclosure can include, after obtaining the conversation record, analyzing the conversation record to obtain the plurality of question-answer pairs. Each question-answer pair can include the first conversation as the question and the second conversation as the step. The step can be a step of the solution corresponding to the question in the question-answer pair. One question can correspond to at least one solution, and one solution can include at least one step. The method can further include determining the solution corresponding to each question in the conversation record based on the features of the step, displaying the questions and the corresponding solutions in sequence based on the generation process of the questions in the conversation record to obtain the target abstract content of the conversation record. In the present disclosure, in the multi-intention conversation scenario, each question-answer pair can be determined first. Then, the question-answer pairs can be sorted to obtain the target abstract content. That is, even the sequence of the conversations is chaotic in the conversation record, the obtained target abstract content is not affected by the chaotic conversations in the conversation record. Thus, the target abstract content can have a good quality. Further, the noise data of the conversation record does not belong to any question-answer pair. Thus, the recognized conversation information that does not belong to any question-answer pair cannot be added to the target abstract content. Therefore, the noise data can be removed from the conversation record.

FIG. 4 illustrates a schematic flowchart of an information processing method according to embodiments of the present disclosure. The method includes the following processes.

At S401, the conversation record is obtained.

Process S401 can be the same as process S101 and is not described in detail here.

At S402, based on a pairing model, pairing analysis is performed on the first conversation and the second conversation in the conversation record, and the first conversation and the second conversation that satisfy a question-answer pairing condition form the question-answer pair.

The first conversation satisfying the question-answer pairing condition can be used as the question of the question-answer pair. The second conversation satisfying the question-answer pairing condition can be used as the step of the question-answer pair.

The electronic apparatus can include a predetermined pairing model. The pairing analysis can be performed on the first conversation and the second conversation in the conversation record to obtain the question-answer pair.

For example, the pairing model can be an ispairs model. The ispairs model can be configured to identify whether any first conversation and any second conversation can form a challenge-answer pair.

In some embodiments, one first conversation can be selected from the first conversations, and one first conversation can be selected from the second conversations. The pairing model can determine whether the first conversation and the second conversation satisfy the question-answer pairing condition. If the first conversation and the second conversation satisfy the question-answer pairing condition, the first conversation and the second conversation can form the question-answer pair. If the first conversation and the second conversation do not satisfy the question-answer pairing condition, the first conversation and the second conversation cannot form the question-answer pair.

In some embodiments, since the second conversation object replies to the first conversation of the first conversation object, to reduce a data processing volume of the pairing model, the second conversation that appears after the moment of the first conversation after the first conversation is selected. The pairing model can determine whether the first conversation and the second conversation satisfy the question-answer pairing condition. If the first conversation and the second conversation satisfy the question-answer pairing condition, the first conversation and the second conversation can form the question-answer pair. If the first conversation and the second conversation do not satisfy the question-answer pairing condition, the first conversation and the second conversation cannot form the question-answer pair.

If one first conversation is selected from the first conversations, and none of the second conversations can satisfy the question-answer pairing condition with the first conversation, the first conversation can be ignored. The first conversation can be used as noise. Another first conversation can be continuously selected. Whether the second conversation and the first conversation that is continuously selected satisfy the question-answer pairing condition can be determined.

At S403, the solution corresponding to each question is determined in the conversation record based on the features of the step.

At S404, based on the generation process of the questions in the conversation record, the questions and the corresponding solutions are displayed in sequence to obtain the target abstract content in the conversation record.

Processes S403 and 404 are consistent with processes S103 and 104 and are not described in detail here.

In summary, the information processing method of embodiments of the present disclosure can include performing the pairing analysis on the first conversation and the second conversation in the conversation record based on the pairing model and forming the first conversation and the second conversation that satisfy the question-answer pairing condition into the question-answer pair. The first conversation that satisfies the question-answer pairing condition can be used as the question of the question-answer pair, and the second conversation that satisfies the question-answer pairing condition can be used as the step of the question-answer pair. In the present disclosure, the first conversation and the second conversation that satisfy the question-answer condition can form the question-answer pair. The first conversation and the second conversation that do not satisfy the question-answer condition cannot form the question-answer pair. Thus, the conversation with the valid question-answer content can be included in the target abstract content, and the invalid question-answer content cannot be included in the target abstract content. Therefore, the noise data can be removed from the conversation record.

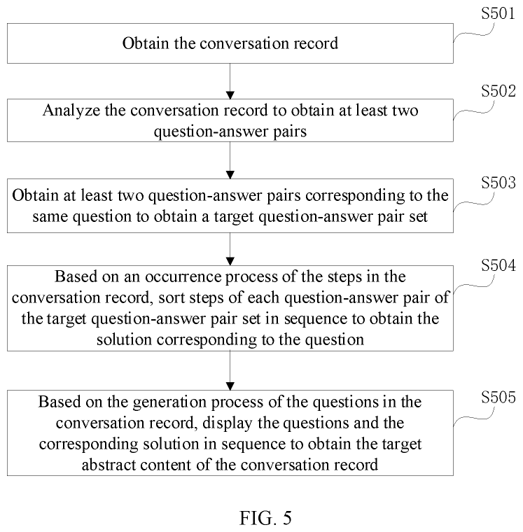

FIG. 5 illustrates a schematic flowchart of an information processing method according to embodiments of the present disclosure. The method includes the following processes.

At S501, the conversation record is obtained.

At S502, the conversation record is analyzed to obtain at least two question-answer pairs.

Processes S501 and 502 are consistent with processes S101 and 102 and are not described in detail here.

At S503, at least two question-answer pairs corresponding to the same question are obtained to obtain a target question-answer pair set.

The obtained plurality of question-answer pairs can be divided into sets according to the corresponding questions.

In some embodiments, a certain question can be selected, and all question-answer pairs corresponding to the certain question can be determined. All the question-answer pairs corresponding to the certain question can be used as the target question-answer pair set of the certain question.

When a certain question only has one question-answer pair, the question-answer pair can also be directly regarded as the question-answer pair set of the question. The question-answer pair set can be a set of a single element.

For example, a plurality of question-answer pairs can be filtered to obtain question-answer pairs corresponding to question Q2. The question-answer pairs can include Q2-A21 and Q2-A22. Question-answer pairs of question Q4 can be obtained and include Q4-A41, Q4-A42, Q4-A43, and Q4-A44. Question-answer pairs Q4-A41, Q4-A42, Q4-A43, and Q4-A44 can be combined to obtain the question-answer pair set, and question-answer pairs Q2-A21 and Q2-A22 can be combined to obtain the question-answer pair set.

At S504, based on an occurrence process of the steps in the conversation record, steps of each question-answer pair of the target question-answer pair set are sorted in sequence to obtain the solution corresponding to the question.

If the solution to a certain question in the conversation record includes a plurality of steps, the customer service can reply according to the sequence of the steps when replying to the question. Thus, the sequence of the steps of the solution can be determined in the conversation record based on the sequence of the occurrence of the steps corresponding to the same question in the conversation record to obtain the solution to the question.

For example, in the question-answer pair set of Q4-A41, Q4-A42, Q4-A43, and Q4-A44, the sequence of the steps appearing in the conversation record can be A41, A42, A43, and A44. The steps can be sorted in sequence to obtain the solution corresponding to question Q4. The solution can include steps A41, A42, A43, and A44.

At S505, based on the generation process of the questions in the conversation record, the questions and the corresponding solution are displayed in sequence to obtain the target abstract content of the conversation record.

Process S505 can be consistent with process S104 and is not repeated here.

In summary, the information processing method of embodiments of the present disclosure can include obtaining the at least two question-answer pairs corresponding to the same question to obtain the target question-answer pair set, and based on the occurrence process of the steps in the conversation record, sorting the steps of each question-answer pair in the target question-answer pair set in sequence to obtain the solution corresponding to the question. In the present disclosure, the plurality of question-answer pairs corresponding to the same question can be combined into the target question-answer pair set. The steps of each question-answer pair in the target question-answer pair set can be sorted in sequence based on the occurrence sequence of the steps in the conversation record to obtain the solution corresponding to the question. Thus, the solution corresponding to the question can be determined.

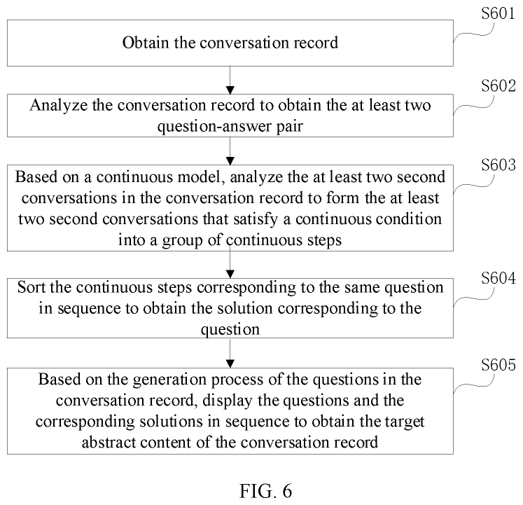

FIG. 6 illustrates a schematic flowchart of an information processing method according to embodiments of the present disclosure. The method includes the following processes.

At S601, the conversation record is obtained.

At S602, the conversation record is analyzed to obtain the at least two question-answer pairs.

Processes S601 and 602 are consistent with processes S101 and 102 and are not described in detail here.

At S603, based on a continuous model, the at least two second conversations in the conversation record are analyzed to form the at least two second conversations that satisfy a continuous condition into a group of continuous steps.

Any group of continuous steps can correspond to the same question. The group of continuous steps can be a solution.

The electronic apparatus can include a predetermined continuous model. The continuous model can be configured to determine whether any two second conversations in the conversation record satisfy the continuous condition. The second conversations that satisfy the continuous condition can form a group of continuous steps.

For example, the continuation model can include an isnext model. The isnext model can be configured to determine whether any two second conversations are continuous steps.

In some embodiments, since the second conversation object replies to the first conversation of the first conversation object and sequentially provides the steps of the replied solution as feedback in sequence, the sequence of the steps generated by the second conversations for the same solution can be determined. Thus, to reduce the data processing amount of the continuous model, after a certain second conversation is selected, a second conversation can be selected from second conversations that appear after the moment of the certain second conversation. Then, whether the two second conversations satisfy the continuous condition can be determined.

For example, the continuous condition can include two steps being continuous, three steps being continuous, or more steps being continuous.

In some embodiments, two steps being continuous can be described as the continuous condition.

The second conversations included in the conversation record can include step A1, step A21, step A22, step A3, step A41, step A42, step A43, and step A44. Any two second conversations can be sequentially obtained. The second conversations that satisfy the continuous condition can be determined to be step A21 and step A22, step A41 and step A42, step A42 and step A43, and step A43 and step A44.

At S604, the continuous steps corresponding to the same question are sorted in sequence to obtain the solution corresponding to the question.

The continuous steps corresponding to the same question can have continuity. The continuous steps corresponding to the same question can be sorted to obtain the solution corresponding to the question.

For example, continuous step A41 and step A42, continuous step A42 and step A43, and continuous step A43 and step A44 can correspond to question 4. Based on the continuity of the continuous steps, the 3 groups of continuous steps can be sorted in sequence to obtain step A41, step A42, step A43, and step A44. The 4 continuous steps can be the solution corresponding to question 4.

At S605, based on the generation process of the questions in the conversation record, the questions and the corresponding solutions are displayed in sequence to obtain the target abstract content of the conversation record.

Process S605 can be consistent with process S104 and is not repeated here.

In summary, the information processing method of embodiments of the present disclosure can include analyzing the at least two second conversations in the conversation record based on the continuous model and forming the at least two second conversations that satisfy the continuous condition into the group of continuous steps. Any group of continuous steps can correspond to the same question. The group of continuous steps can be the solution. The method can further include sorting the continuous steps corresponding to the same question to obtain the solution corresponding to the question. In the present disclosure, based on the continuity of the continuous steps, the plurality of continuous steps can be sorted to obtain the solution corresponding to the question.

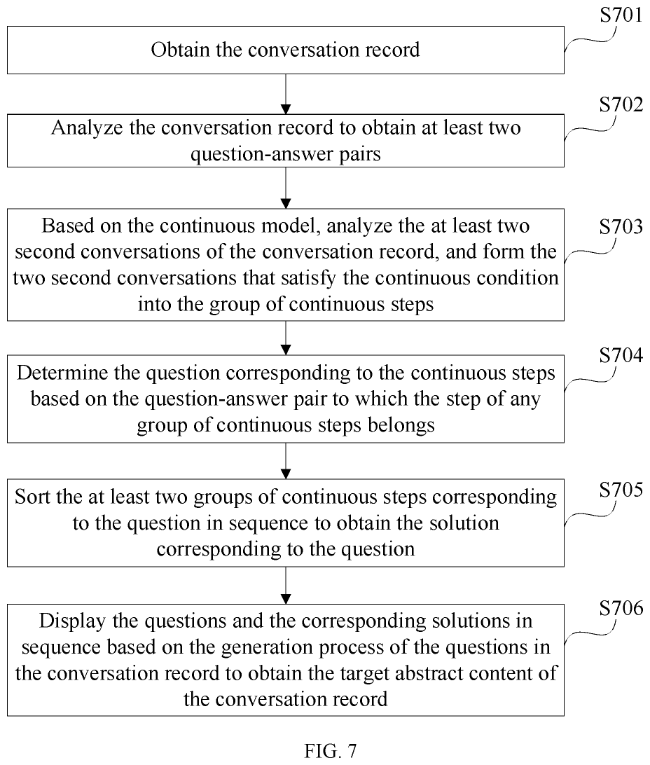

FIG. 7 illustrates a schematic flowchart of an information processing method according to embodiments of the present disclosure. The method includes the following processes.

At S701, the conversation record is obtained.

At S702, the conversation record is analyzed to obtain at least two question-answer pairs.

At S703, based on the continuous model, the at least two second conversations of the conversation record are analyzed, and the two second conversations that satisfy the continuous condition form the group of continuous steps.

Processes S701 to 703 are consistent with processes S601 to 603 and are not repeated here.

At S704, the question corresponding to the continuous steps is determined based on the question-answer pair to which the step of any group of continuous steps belongs.

After a plurality of groups of continuous steps are obtained based on the second conversations of the conversation record, a relationship between the plurality of groups of continuous steps may need to be further determined to determine whether the plurality of groups of continuous steps can form the solution of the same question.

In the solution of embodiments of the present disclosure, the plurality of groups of continuous steps corresponding to the same question is taken as an example.

In some embodiments, since each step corresponds to the same question in the group of consecutive steps, the question corresponding to the question-answer pair to which the step belongs can be determined based on the question-answer pair to which any step of the group of continuous steps belongs. The question can be the question corresponding to the groups of the continuous steps.

For example, the second conversations that satisfy the continuous condition included in the conversation record can include step A21 and step A22, step A41 and step A42, step A42 and step A43, and step A43 and step A44. Continuous step A21 and step A22 can be determined to correspond to question 2. Step A41 and step A42 can correspond to question 4, step A42 and step A43 can correspond to question 4, and step A43 and step A44 can correspond to question 4.

At S705, the at least two groups of continuous steps corresponding to the question are sorted in sequence to obtain the solution corresponding to the question.

If two or even more groups of continuous steps correspond to the same question, the continuous steps corresponding to the same question can be sorted in sequence according to the continuity of the plurality of groups of continuous steps to obtain the solution corresponding to the question.

For example, continuous step A41 and step A42, continuous step A42 and step A43, and continuous step A43 and step A44 can correspond to question 4. Based on the continuity of the continuous steps, the 3 groups of continuous steps can be sorted in sequence to obtain step A41, step A42, step A43, and step A44. The 4 continuous steps can be the solution corresponding to question 4.

At S706, the questions and the corresponding solutions are displayed in sequence based on the generation process of the questions in the conversation record to obtain the target abstract content of the conversation record.

Process S706 can be consistent with process S605 and is not repeated here.

In summary, the information processing method of embodiments of the present disclosure can include determining the question corresponding to the continuous step based on the question-answer pair to which the step of any group of the continuous steps belongs and sorting the at least two groups of continuous steps corresponding to the question in sequence to obtain the solution corresponding to the question. In the present disclosure, based on the question-answer pair to which any step of the continuous steps belongs, the question corresponding to the step can be determined to obtain the question corresponding to the continuous steps. Then, based on the continuity of the continuous steps, the plurality of continuous steps can be sorted in sequence to obtain the solution corresponding to the question.

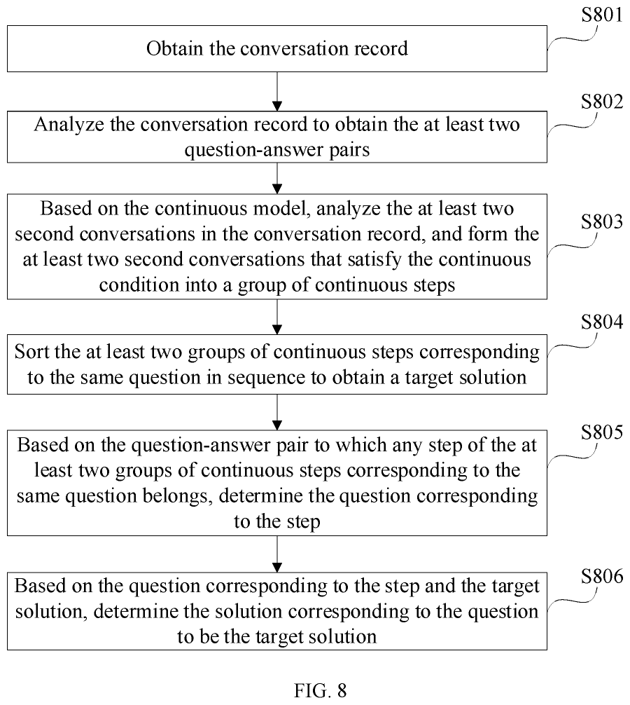

FIG. 8 illustrates a schematic flowchart of an information processing method according to embodiments of the present disclosure. The method includes the following processes.

At S801, the conversation record is obtained.

At S802, the conversation record is analyzed to obtain the at least two question-answer pairs.

At S803, based on the continuous model, the at least two second conversations in the conversation record are analyzed. The at least two second conversations that satisfy the continuous condition form a group of continuous steps.

Processes S801 to 803 are consistent with processes S601 to 603 and are not repeated here.

At S804, the at least two groups of continuous steps corresponding to the same question are sorted in sequence to obtain a target solution.

In embodiments of the present disclosure, the plurality of groups of continuous steps corresponding to the same question can be taken as an example for description.

After the plurality of groups of continuous steps are obtained based on the second conversations of the conversation record, the plurality of groups of continuous steps corresponding to the same problem can be sorted based on the continuity of the continuous steps.

In some embodiments, the plurality groups of continuous steps can be sorted based on the continuity of the continuous steps. The continuous steps can only be determined to correspond to the same question. However, which specific question corresponding to the continuous steps cannot be determined.

For example, the second conversations that satisfy the continuous condition and are included in the conversation record can include step A21 and step A22, step A41 and step A42, step A42 and step A43, and step A43 and step A44. Based on the continuity of the continuous steps, the plurality of groups of continuous step A41 and step A42, step A42 and step A43, and step A43 and step A44 that correspond to the same question can be combined to obtain the solution. The solution can include step A41, step A42, step A42, step A43, step A43, and step A44. Another solution can be directly obtained from step A21 and step A22.

At S805, based on the question-answer pair to which any step of the at least two groups of continuous steps corresponding to the same question belongs, the question corresponding to the step is determined.

The plurality of groups of continuous steps determined to correspond to a same target solution can correspond to the same question. Any step can be selected from the plurality groups of continuous steps. Then, the question-answer pair to which the step belongs can be determined. The question corresponding to the step can be obtained based on the question-answer pair to which the step belongs.

At S806, based on the question corresponding to the step and the target solution, the solution corresponding to the question is determined to be the target solution.

Since the plurality of groups of continuous steps belonging to the same target solution correspond to the same question, the corresponding question determined based on a certain step can be the question corresponding to the target solution.

Accordingly, based on the problem corresponding to the step and the target solution, the solution corresponding to the question can be determined to be the target solution.

In some embodiments, when a plurality of target solutions are included in the conversation record, the corresponding relationship between the plurality questions and the target solutions involved in the conversation record can be determined.

At S807, the questions and the corresponding solutions are displayed in sequence based on the generation process of the questions in the conversation record to obtain the target abstract content of the conversation record.

Process S807 is consistent with process S605 and is not repeated here.

In summary, the information processing method of embodiments of the present disclosure can include sorting the at least two groups of continuous steps corresponding to the same problem in sequence to obtain the target solution, determining the question corresponding to the step based on the question-answer pair to which any step of the at least two groups of continuous steps corresponding to the same question belongs, and determining the solution corresponding to the question to be the target solution based on the question corresponding to the step and the target solution. In the present disclosure, the plurality of groups of continuous steps belonging to the same solution can be determined. Then, the question corresponding to any step in the solution can be determined to determine the question corresponding to the solution. Then, the solution corresponding to the question that is obtained based on the question and the solution can be the target solution.

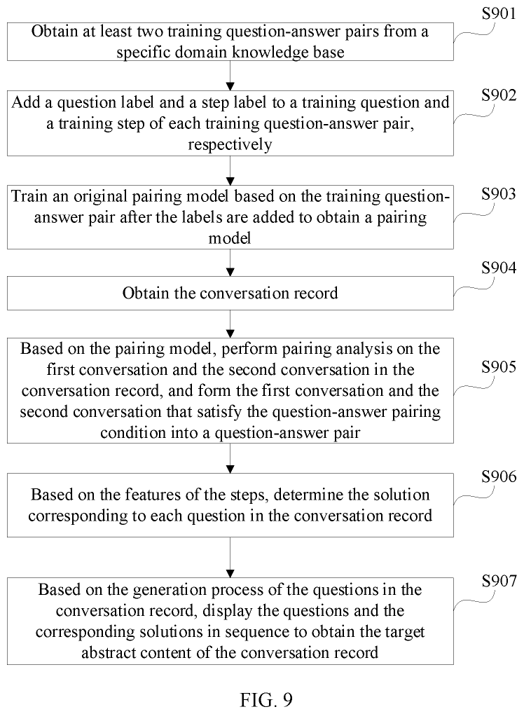

FIG. 9 illustrates a schematic flowchart of an information processing method according to embodiments of the present disclosure. The method includes the following processes.

At S901, at least two training question-answer pairs are obtained from a specific domain knowledge base.

Based on the field related to the method, a corresponding domain knowledge base can be determined. The knowledge base can include questions in the field and corresponding solution steps.

A question and a training question-answer pair can be obtained from a step in a solution corresponding to the question can be obtained from the domain knowledge base. Similarly, a plurality of training question-answer pairs can be obtained from the domain knowledge base.

The questions and the corresponding solution steps stored in the domain knowledge base can content written in the data in advance and can be used to provide feedback to a question asked by the user.

At S902, a question label and a step label are added to a training question and a training step of each training question-answer pair, respectively.

One question-answer pair can include one training question and one training step, which have a correct question-answer relationship.

In some embodiments, the question label can be added to the training question of each training question-answer pair, and the step label can be added to the training step of each training question-answer pair.

At S903, an original pairing model is trained based on the training question-answer pair after the labels are added to obtain a pairing model.

The original pairing model can be trained using the training question-answer pair added with the question label and the step label. The pairing model can determine whether a first conversation and a second conversation in the conversation record form a question-answer pair.

In some embodiments, to improve training accuracy, the training question-answer pair can be used as a positive sample, and a negative sample can be also obtained. The original pairing model can be trained based on the positive sample and the negative sample to obtain the pairing model.

For example, for problem Q, a plurality of solutions can be provided, i.e., S1 and S2. Solution S1 can include step S11 and step S12. Solution 2 can include step S21, step S22, and step S23. The obtained positive sample can include [(Q, S11), (Q, S12), (Q, S21), (Q, S22), (Q, S23)]. One or more steps of another question can be obtained randomly in domain data. The step can be irrelative to the step in the solution of question Q, such as S′, to obtain the negative sample (Q, S′).

To improve the training accuracy, when the negative sample is generated, selected step S′ may need to be different from the step in the positive sample.

A data volume of a certain domain database can be small. Entire data can be used as training samples to train the original pairing model. If the data volume of a certain domain database is large, a part of the data can be selected as the training sample. The data volume sampled in the domain data is not limited to the present disclosure.

At S904, the conversation record is obtained.

At S905, based on the pairing model, pairing analysis is performed on the first conversation and the second conversation in the conversation record, and the first conversation and the second conversation that satisfy the question-answer pairing condition form a question-answer pair.

At S906, based on the features of the steps, the solution corresponding to each question in the conversation record is determined.

At S907, based on the generation process of the questions in the conversation record, the questions and the corresponding solutions are displayed in sequence to obtain the target abstract content of the conversation record.

Processes S904 to S907 are consistent with processes S401 to S404 and are not repeated here.

In summary, the information processing method of embodiments of the present disclosure can further include obtaining the at least two training question-answer pairs in the specific domain knowledge base, adding the question label and the step label to the training question and the training step in each training question-answer pair, respectively, and training the original pairing model based on the training question-answer pair added with the labels to obtain the pairing model. In the present disclosure, the original pairing model can be trained based on the data in the specific domain knowledge base to obtain the pairing model. The pairing model can be trained with real data and have high accuracy.

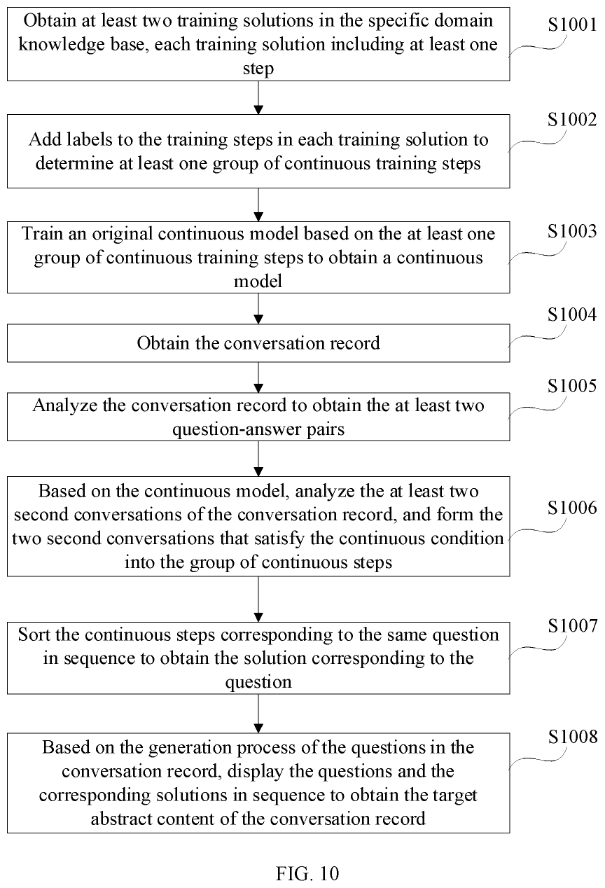

FIG. 10 illustrates a schematic flowchart of an information processing method according to embodiments of the present disclosure. The method includes the following processes.

At S1001, at least two training solutions are obtained in the specific domain knowledge base, and each training solution includes at least one step.

Based on the field related to the method, a corresponding domain knowledge base can be determined. The knowledge base can store the questions in the field and the corresponding solution steps.

A plurality of solutions can be obtained from the domain knowledge base. The plurality of solutions can be used as the training solutions.

The solution steps stored in the domain knowledge base can be written in the data in advance and can be used to provide feedback to the questions asked by the user.

At S1002, labels are added to the training steps in each training solution to determine at least one group of continuous training steps.

The label can be added to each training step in the training solution. The label can be used to represent that the plurality of training steps are in the same training solution and represent the sequence of the training steps.

The label can be added to each training step of the obtained plurality of training solutions in sequence. The plurality of steps in sequence belonging to the same training solution can be determined based on the label.

For example, the training solution S can have steps [t1, t2, t3, t4] with sequence. Three groups of continuous training steps [t1, t2], [t2, t3], and [t3, t4] can be obtained based on the training solution.

In some embodiments, a number of steps in a group of continuous training steps can be 2 by considering a computation volume. The computation volume for the number of 2 can be small. The whole of the solution can be determined based on the continuity of the steps.

The number of steps in a group of continuous training steps can be set according to an actual situation, for example, 2, 3, 4, etc. The number is not limited in the present disclosure.

At S1003, an original continuous model is trained based on the at least one group of continuous training steps to obtain a continuous model.

The original continuous model can be trained by using the continuous training steps added with the labels. Thus, the original continuous model can be trained to obtain the continuous model. The continuous model can determine whether any two or more second conversations in the conversation record are continuous steps.

In some embodiments, to improve the training accuracy, the continuous training steps can be used as the positive sample, and the negative sample can also be obtained. The original continuous model can be trained based on the positive sample and the negative sample to obtain the continuous model.

For example, the training solution S can include steps [t1, t2, t3, t4] with sequence. Three groups of continuous training steps [t1, t2], [t2, t3], and [t3, t4] can be obtained based on the training solution. The positive sample can be obtained and include [t1, t2], [t2, t3], and [t3, t4]. One or more steps in another solution can be randomly obtained in the domain data. The step can be irrelative to the steps in solution S, such as t1′, and t 2′. The negative sample of (t1′, t 2′) can be obtained.

To improve the training accuracy, when the negative sample is generated, the selected step (t1′, t 2′) may need to include a step different from the step of the positive sample.

A data volume in a certain domain database can be small. The original continuous model can be trained using all data as the training sample. If the data volume of the certain domain database is large, a part of the data can be used as the training sample. The data volume sampled in the domain data is not limited to the present disclosure.

At S1004, the conversation record is obtained.

At S1005, the conversation record is analyzed to obtain the at least two question-answer pairs.

At S1006, based on the continuous model, the at least two second conversations of the conversation record are analyzed, and the two second conversations that satisfy the continuous condition form the group of continuous steps.

At S1007, the continuous steps corresponding to the same question are sorted in sequence to obtain the solution corresponding to the question.

At S1008, based on the generation process of the questions in the conversation record, the questions and the corresponding solutions are displayed in sequence to obtain the target abstract content of the conversation record.

Processes S1004 to S1008 are consistent with processes S601 to S605 and are not repeated here.

In summary, the information processing method of embodiments of the present disclosure can further include obtaining the at least two training solutions in a specific domain knowledge base, each training solution including at least one step, adding the labels to the steps of each training solution to determine the at least one group of continuous training steps, and training the original continuous model based on the at least one group of continuous training steps to obtain the continuous model. In the present disclosure, the original continuous model can be trained based on the data in the specific domain base to obtain the continuous model. The training can be based on real data and have high accuracy.

Corresponding to the information processing method of embodiments of the present disclosure, the present disclosure further provides a device to apply the information processing method.

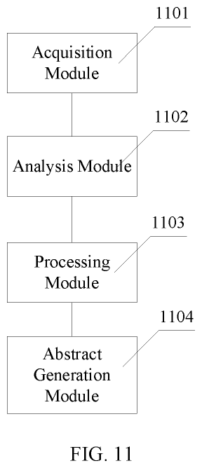

FIG. 11 illustrates a schematic flowchart of an information processing device according to embodiments of the present disclosure. The device includes an acquisition module 1101, an analysis module 1102, a determination module 1103, and an abstract generation module 1104.

The acquisition module 1101 can be configured to obtain the conversation record. The conversation record can at least include the first conversation generated by the first conversation object and the second conversation generated by the second conversation object.

The analysis module 1102 can be configured to analyze the conversation record to obtain the at least two question-answer pairs. Each question-answer pair can include the first conversation as the question and the second conversation as the step. The step can be a step of the solution corresponding to the question in the question-answer pair. One question can correspond to at least one solution. One solution can include at least one step.

The determination module 1103 can be configured to determine the solution corresponding to each question in the conversation record based on the features of the step.

The abstract generation module 1104 can be configured to display the questions and the corresponding solutions in sequence based on the generation process of the questions in the conversation record to obtain the target abstract content of the conversation record.

In some embodiments, the analysis module can be configured to perform the pairing analysis on the first conversation and the second conversation in the conversation record based on the pairing model. The first conversation satisfying the question-answer pairing conduction can be used as the question of the question-answer pair. The second conversation satisfying the question-answer pairing condition can be used as the steps of the question-answer pair.

In some embodiments, the determination module can be configured to obtain the at least two question-answer pairs corresponding to the same question to obtain the target question-answer pair set and, based on the occurrence process of the steps in the conversation record, sort the steps of each question-answer pair in the target question-answer pair set to obtain the solution corresponding to the question.

In some embodiments, the determination module can be configured to analyze the at least two second conversations in the conversation record based on the continuous model. the determination module can be further configured to form the at least two second conversations satisfying the continuous condition into the group of continuous steps. Each group of continuous steps can correspond to the same question. The group of continuous steps can be the solution. The determination module can be further configured to sort the continuous steps corresponding to the same question in sequence to obtain the solution corresponding to the question.

In some embodiments, if at least two groups of continuous steps correspond to the same question, the abstract generation module can be configured to determine the question corresponding to the continuous steps based on the question-answer pair to which the steps of any group of continuous steps and sort the at least two groups of continuous steps corresponding to the question in sequence to obtain the solution corresponding to the question.

In some embodiments, if the at least two groups of continuous steps correspond to the same question, the abstract generation module can be configured to sort the at least two groups of continuous steps corresponding to the same question to obtain the target solution, based on the question-answer pair to which any step of the at least two groups of continuous steps corresponding to the same question, determine the question corresponding to the step, and determine the solution corresponding to the question as the target solution based on the question corresponding to the step and the target solution.

In some embodiments, the device can further include a first training module.

The first training module can be configured to obtain the at least two training question-answer pairs in the specific domain knowledge base, add the question labels and the step labels to the training questions and the training steps in each training question-answer pair, and train the original pairing model at least based on the training question-answer pair added with the labels to obtain the pairing model.

In some embodiments, the device can further include a second training module.

The second training module can be configured to obtain the at least two training solutions in the specific domain knowledge base. Each training solution can include at least one step. The second training module can be configured to add the labels to the training steps of each training solution in sequence to determine the at least one group of training continuous steps and train the original continuous model based on the at least one group of continuous training steps to obtain the continuous model.

For the structural functions of the information processing device, reference can be made to the method embodiments above, which are not repeated here.

In summary, the present disclosure provides the information processing device. In the multi-intention conversation scenario, each question-answer pair can be determined first. Then, the overall conversations can be sorted according to the question-answer pairs to obtain the target abstract content. Even if the conversations of the conversation record have a chaotic sequence, the obtained target abstract content cannot be affected by the chaotic sequence of the conversations in the conversation record. The quality of the target abstract content can be high. Moreover, the noise data in the conversation record cannot belong to any question. Thus, the obtained conversation information not belonging to any question cannot be added to the target abstract content. Therefore, the noise data can be removed from the conversation record.

Corresponding to the information processing method of embodiments of the present disclosure. The present disclosure can further provide an electronic apparatus and a readable storage medium corresponding to the information processing method.

The electronic apparatus can include a memory and a processor.

The memory stores a processing program.

The processor can be configured to load and execute the processing program stored in the memory to implement the steps of any of the information processing methods above.

In some embodiments, for the information processing method implemented by the electronic apparatus, reference can be made to the information processing methods above.

The readable storage medium can store a computer program that, when executed by the processor, caused the processor to implement the steps of any of the information processing methods above.

In some embodiments, for the information processing method implemented by the computer program stored in the readable storage medium, reference can be made to the information processing methods above.

Embodiments of the present disclosure are described in a progressive manner. Each embodiment focuses on differences from other embodiments. The same and similar parts among embodiments can be referred to each other. For the device of embodiments of the present disclosure, since the device corresponds to the methods of embodiments of the present disclosure, the description can be simple. The relevant part can be referred to in the description of the method part.

The previous description of embodiments of the present disclosure can be provided to enable those skilled in the art to make or use the present disclosure. Various modifications to these embodiments are apparent to those skilled in the art. The generic principles defined here can be applied to other embodiments without departing from the spirit or scope of the present disclosure. Thus, the present disclosure is not limited to embodiments of the present disclosure but conforms to the widest scope consistent with the principles and novel features of the present disclosure.

What is claimed is:

1. An information processing method, comprising:
obtaining a conversation record including a first conversation generated by a first conversation object and a second conversation generated by a second conversation object;
analyzing the conversation record to obtain at least two question-answer pairs, each question-answer pair including the first conversation as a question and the second conversation as a step, the step being a step of a solution corresponding to the question of the question-answer pair, one question corresponding to at least one solution, one solution including at least one step;
determining a solution corresponding to each question in the conversation record based on features of the step; and
displaying the question and the corresponding solution based on a generation process of the question in the conversation record to obtain a target abstract content of the conversation record.

2. The method of claim 1, wherein analyzing the conversation record to obtain the at least two question-answer pairs includes:
performing pairing analysis on the first conversation and the second conversation in the conversation record based on a pairing module;
forming the first conversation and the second conversation satisfying a question-answer pairing condition into a question-answer pair, the first conversation satisfying the question-answer pairing condition being used as the question of the question-answer pair, and the second conversation satisfying the question-answer pairing condition being used as the step of the question-answer pair.

3. The method of claim 1, wherein determining the solution corresponding to each question in the conversation record based on the features of the step includes:
obtaining at least two question-answer pairs corresponding to a same question to obtain a target question-answer pair set; and
sorting steps of each question-answer pair of the target question-answer pair set in sequence based on an occurrence process of the step in the conversation record to obtain the solution corresponding to the question.

4. The method of claim 1, wherein determining the solution corresponding to each question-answer pair of the conversation record based on the features of the step includes:
analyzing the at least two second conversations of the conversation record based on a continuous model;
forming the at least two second conversations that satisfy a continuous condition into a group of continuous steps, the group of continuous steps corresponding to a same question, the group of continuous steps being a solution; and
sorting the continuous steps corresponding to the same question in sequence to obtain the solution corresponding to the question.

5. The method of claim 4, wherein if at least two groups of continuous steps correspond to the same question, soring the continuous steps corresponding to the same question to obtain the solution corresponding to the question includes:
determining the question corresponding to the continuous steps based on the question-answer pair to which a step of any group of continuous steps belongs;
sorting the at least two groups of continuous steps corresponding to the question to obtain the solution corresponding to the question.

6. The method of claim 4, wherein if the at least two groups of continuous steps correspond to the same question, sorting the continuous steps corresponding to the same question in sequence to obtain the solution corresponding to the question includes:
sorting the at least two groups of continuous steps corresponding to the same question to obtain a target solution;
based on a question-answer pair to which any step of the at least two groups of continuous steps corresponding to the same question belongs, determining a question corresponding to the step; and
based on the question corresponding to the step and the target solution, determining a solution corresponding to the question as the target solution.

7. The method of claim 2, further comprising, before obtaining the conversation record:
obtaining at least two training question-answer pairs in a specific domain knowledge base;
adding a question label and a step label to a training question and a training step of each training question-answer pair, respectively; and
training an original pairing model based on a training question-answer pair added with labels to obtain a pairing model.

8. The method of claim 4, further comprising, before obtaining the conversation record:
obtaining at least two training solutions in a specific domain knowledge base, each training solution including at least one step;
adding labels to training steps of each training solution in sequence to determine at least one group of continuous steps; and
training an original continuous model based on the at least one group of continuous training steps to obtain a continuous model.

9. An information processing device, comprising:
an acquisition module configured to obtain a conversation record, the conversation record including a first conversation generated by a first conversation object and a second conversation generated by a second conversation object;
an analysis module configured to analyze the conversation record to obtain at least two question-answer pairs, each question-answer pair including the first conversation as a question and the second conversation as a step, the step being a step of a solution corresponding to the question of the question-answer pair, one question corresponding to at least one solution, one solution including at least one step;
a determination module configured to determine a solution corresponding to each question in the conversation record based on features of the step; and
an abstract generation module configured to display the question and the corresponding solution based on a generation process of the question in the conversation record to obtain a target abstract content of the conversation record.

10. The device of claim 9, wherein the analysis module is further configured to:
perform pairing analysis on the first conversation and the second conversation in the conversation record based on a pairing module;
form the first conversation and the second conversation satisfying a question-answer pairing condition into a question-answer pair, the first conversation satisfying the question-answer pairing condition being used as the question of the question-answer pair, and the second conversation satisfying the question-answer pairing condition being used as the step of the question-answer pair.

11. The device of claim 9, wherein the determination module is further configured to:
obtain at least two question-answer pairs corresponding to a same question to obtain a target question-answer pair set; and
sort steps of each question-answer pair of the target question-answer pair set in sequence based on an occurrence process of the step in the conversation record to obtain the solution corresponding to the question.

12. The device of claim 9, wherein the analysis module is further configured to:
analyze the at least two second conversations of the conversation record based on a continuous model;
form the at least two second conversations that satisfy a continuous condition into a group of continuous steps, the group of continuous steps corresponding to a same question, the group of continuous steps being a solution; and
sort the continuous steps corresponding to the same question in sequence to obtain the solution corresponding to the question.

13. A non-transitory computer-readable storage medium storing a computer program that, when executed by a processor, causes the processor to:
obtain a conversation record including a first conversation generated by a first conversation object and a second conversation generated by a second conversation object;
analyze the conversation record to obtain at least two question-answer pairs, each question-answer pair including the first conversation as a question and the second conversation as a step, the step being a step of a solution corresponding to the question of the question-answer pair, one question corresponding to at least one solution, one solution including at least one step;
determine a solution corresponding to each question in the conversation record based on features of the step; and
display the question and the corresponding solution based on a generation process of the question in the conversation record to obtain a target abstract content of the conversation record.

14. The storage medium of claim 13, wherein the processor is further configured to:
perform pairing analysis on the first conversation and the second conversation in the conversation record based on a pairing module; and
form the first conversation and the second conversation satisfying a question-answer pairing condition into a question-answer pair, the first conversation satisfying the question-answer pairing condition being used as the question of the question-answer pair, and the second conversation satisfying the question-answer pairing condition being used as the step of the question-answer pair.

15. The storage medium of claim 13, wherein the processor is further configured to:
obtain at least two question-answer pairs corresponding to a same question to obtain a target question-answer pair set; and
sort steps of each question-answer pair of the target question-answer pair set in sequence based on an occurrence process of the step in the conversation record to obtain the solution corresponding to the question.

16. The storage medium of claim 13, wherein the processor is further configured to:
analyze the at least two second conversations of the conversation record based on a continuous model;
form the at least two second conversations that satisfy a continuous condition into a group of continuous steps, the group of continuous steps corresponding to a same question, the group of continuous steps being a solution; and
sort the continuous steps corresponding to the same question in sequence to obtain the solution corresponding to the question.

17. The storage medium of claim 16, wherein the processor is further configured to:
determine the question corresponding to the continuous steps based on the question-answer pair to which a step of any group of continuous steps belongs;
sort the at least two groups of continuous steps corresponding to the question to obtain the solution corresponding to the question.

18. The storage medium of claim 16, wherein the processor is further configured to:
sort the at least two groups of continuous steps corresponding to the same question to obtain a target solution;
based on a question-answer pair to which any step of the at least two groups of continuous steps corresponding to the same question belongs, determine a question corresponding to the step; and
based on the question corresponding to the step and the target solution, determine s solution corresponding to the question as the target solution.

19. The storage medium of claim 14, wherein the processor is further configured to:
obtain at least two training question-answer pairs in a specific domain knowledge base;
add a question label and a step label to a training question and a training step of each training question-answer pair, respectively; and
train an original pairing model based on a training question-answer pair added with labels to obtain a pairing model.

20. The storage medium of claim 16, wherein the processor is further configured to:
obtain at least two training solutions in a specific domain knowledge base, each training solution including at least one step;
add labels to training steps of each training solution in sequence to determine at least one group of continuous steps; and
train an original continuous model based on the at least one group of continuous training steps to obtain a continuous model.
